(19) United States
(12) Patent Application Publication
(10) Pub. No.: US 2012/0130534 A1
(43) Pub. Date: May 24, 2012

(54) ACCESS CONTROLLED MEDICATION STORAGE AND INVENTORY CONTROL APPARATUS

(76) Inventor: SCOTT WURM, Celebration, FL (US)

(21) Appl. No.: 13/296,499

(22) Filed: Nov. 15, 2011

Related U.S. Application Data
(60) Provisional application No. 61/415,486, filed on Nov. 19, 2010.

(51) Int. Cl. G06F 17/00; E05B 47/00; A47B 81/00

(52) U.S. Cl. 700/236; 312/209; 700/237

(57) ABSTRACT

An access controlled medication storage and inventory control cabinet includes a main body having an access controlled door for protecting a plurality of containers each configured to store medical items. The cabinet can further include an inventory control module configured to identify each of the medical items stored within the containers and report the same to a central control unit configured to interface with a user, provide access to the cabinet, and control the inventory control module.

### CROSS-REFERENCE TO RELATED APPLICATIONS

This application claims the benefit of U.S. Application Ser. No. 61/415,486 filed on 19 Nov., 2010, the contents of which are incorporated herein by reference.

### BACKGROUND

### Field of the Invention

The present invention relates generally to medication storage devices, and more particularly to an access controlled medication and medical instrument storage apparatus having an integrated inventory control and monitoring system.

Each year, thousands of hospitals, ambulatory surgery centers, nursing homes, and doctor offices struggle with the ever increasing regulatory requirements associated with the storage and distribution of medications, medical instruments, controlled substances and/or drug samples.

There are many known devices and methods that are directed towards storing medications and the like. One of the most basic examples still in use today includes a steel cabinet having a pair of sturdy outer doors and a lock for preventing entry by anyone without a key. Alternatively, other known devices focus on solutions that maintain physical control of medical substances through password protected cabinets. While these solutions provide some protection against unauthorized access, they rely heavily on authorized users to accurately count and record the type and quantity of items they have removed from the cabinet. To this end, when users do not accurately inventory removed items (either through mistake, or due to theft) employees and organizations alike can encounter serious difficulties with authorities and/or medical licensing agencies.

Accordingly, there remains a need for a storage cabinet/device that is capable of providing secure access to the cabinet contents, automated counting of cabinet contents, and inventory management.

### SUMMARY OF THE INVENTION

The present invention is directed to an access controlled medication storage and inventory control cabinet. One embodiment of the present invention can include a main body having an access controlled door for protecting a plurality of containers each configured to store medical items. The cabinet can further include an inventory control module configured to identify each of the medical items stored within the containers and report the same to a central control unit configured to interface with a user, provide access to the cabinet, and control the inventory control module.

Another embodiment of the present invention can include a plurality of different inventory control modules and a user identification system capable of positively identifying a user before granting access to the cabinet contents.

Yet another embodiment of the present invention can include one or more camera's capable of recording a user interaction with the cabinet, and a graphic user interface configured to provide two way communication with a user and to display a list of all items removed from the cabinet by the user.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front view of an access controlled medication storage and inventory control cabinet that is useful for understanding the inventive concepts disclosed herein.

FIG. 2 is a perspective view of an access controlled medication storage and inventory control cabinet in accordance with another embodiment of the present invention.

FIG. 3 is a block diagram of a central control unit for use with the access controlled medication storage and inventory control cabinet in accordance with one embodiment of the invention.

FIG. 4 is a front view of an access controlled medication storage and inventory control cabinet in accordance with an alternate embodiment of the present invention.

FIG. 5 is a flow chart illustrating a method of registering a user and establishing permission settings for accessing the access controlled medication storage and inventory control cabinet in accordance with one embodiment of the invention.

FIG. 6 is a flow chart illustrating a method for accessing items located within the access controlled medication storage and inventory control cabinet in accordance with one embodiment of the invention.

FIG. 7 is a flow chart illustrating a method for performing product inventory utilizing the access controlled medication storage and inventory control cabinet in accordance with one embodiment of the invention.

This summary is provided merely to introduce certain concepts and not to identify key or essential features of the claimed subject matter.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described throughout this document as a cabinet/device for storing medical items, one of skill in the art will recognize that the inventive concepts disclosed herein can applied to a cabinet/enclosure capable of storing any number of items without regard to a particular industry or field. Accordingly, the apparatus is not to be construed as limited to the medical industry.

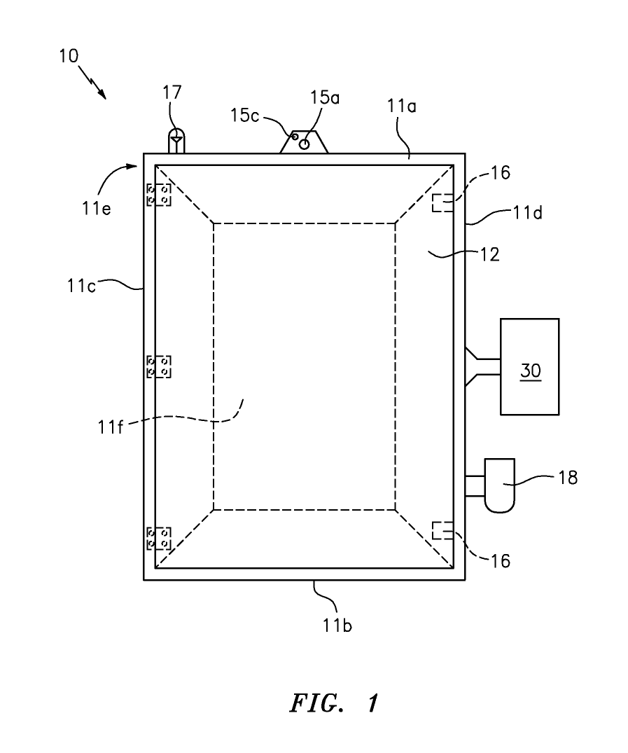

For purposes of this description, the terms “upper,” “bottom,” “right,” “left,” “front,” “vertical,” “horizontal,” and derivatives thereof shall relate to the invention as oriented in FIG. 1.

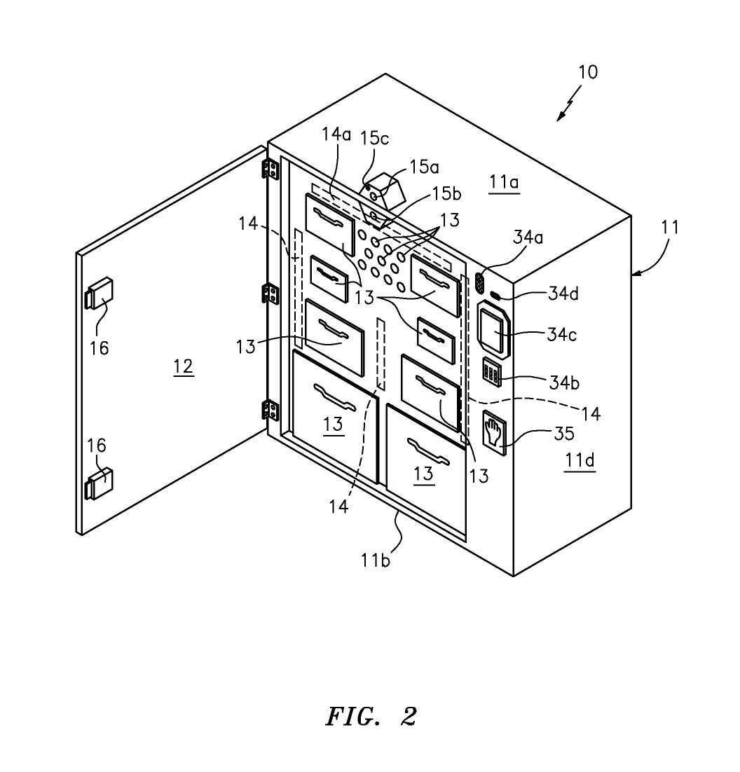

FIGS. 1 and 2 illustrate one embodiment of an access controlled medication storage and inventory control apparatus (e.g., cabinet) 10 that is useful for understanding the inventive concepts disclosed herein. As shown, cabinet 10 can include a main body 11, a plurality of individual compartments 13, one or more inventory control modules 14 and a central control unit 30.

In one embodiment, main body 11 can include a top wall 11a, and a bottom wall 11b having a generally orthogonal relationship with a pair of opposing side walls 11c and 11d, and a back wall 11e, thus forming a cavernous interior space 1 if into which multiple compartments 13 can be located. In one preferred embodiment, each wall of the cabinet can further include a contagion suppression substance, such as an antimicrobial plastic coating, for example, in order to prevent the spread of bacteria, germs and viruses. Additionally, an access door 12 can be hingedly attached to one of the cabinet walls in order to provide a means for accessing the interior of the cabinet 11f.

The door 12 and outer frame 11 can further include one or more locks 16 in order to prevent unauthorized access to the interior of the cabinet. As described herein, each of the one or more locks 16 can be placed anywhere along the frame 11 and/or door 12 and can include any number of known locking systems (i.e. electromagnetic, key, servo etc.) capable of securing the door 12 in a closed position. As will be described below, in one preferred embodiment, each lock 16 can be communicatively linked with the central control unit 30 for allowing access to the cabinet only by authorized users. Locking mechanisms and the associated components are well known to those of skill in the art, therefore no further description will be provided.

An optional waste compartment 18 can be secured to the outside of the cabinet frame 11. Waste compartment can include a steel, plastic or other secure enclosure having a one way opening for allowing a user to deposit spent items such as vials, and syringes, for example.

In one preferred embodiment, the cabinet 10 can include a solid steel construction having an outside dimension of 12×18×6, and will further include mounting hardware such as screws, bolts and lag nuts, for example, in order to allow the cabinet 10 to be permanently secured to a fixed location. Although not illustrated, optional tamper switches can further be included to alert authorities when someone attempts to gain unapproved access to the cabinet. Such a feature can act as a protective mechanism for preventing the cabinet from being moved stolen or vandalized.

Although described above as including specific dimensions shapes and materials, this is for illustrative purposes only, as one of skill in the art will recognize that the cabinet 10 can include any number of different shapes, sizes and materials, depending on the intended use and/or industry to which the cabinet will be used. Additionally, the container can be configured to be permanently mounted to a structure, or can be mobile in nature. Furthermore, one exemplary embodiment can also include a device tracking system 17, such as a GPS or cellular location device capable of allowing authorities to track and locate the cabinet in the event it is stolen. Object tracking systems such as LoJack®, for example, are well known in the art.

FIG. 2 illustrates one embodiment of the cabinet 10 that further includes a plurality of containers 13 for storing medications and the like. As described herein, containers 13 can be constructed to form any type of enclosure ranging from a drawer, tray, bin, shelf, syringe dispenser or other such enclosure, having a shape and dimension that is the same as, or different from the other containers within the cabinet. In one embodiment, one or more containers can be climate controlled through the use of conventional refrigeration and/or heating elements.

In one preferred embodiment, each container 13 can include an electronic locking mechanism (not illustrated) for securing the container in a closed position. As will be described below, the electronic lock of each container 13 can be independently controlled by the central control unit 30 in order to ensure that only authorized users have access to particular containers. As described herein, the electronic locking mechanism will preferably include a commercially available remote activated electromagnetic lock (i.e. mag lock), however other similar locking mechanisms are also contemplated. In operation, each drawer lock will act to independently secure a particular door in a closed position within the cabinet until instructed to open by the central control unit.

As further illustrated in FIG. 2, the cabinet 10, according to one embodiment can also include one or more inventory control modules such as an RFID reader 14 configured to provide an instantaneous count of the cabinet contents at all times. RFID readers are known in the art and can act to receive data from an RFID tag secured to each of the medical items stored within the cabinet. As an item is removed, the RFID reader 14 can capture a description of the item and report the same to the central control unit 30 for inventory purposes.

Although described above as utilizing an RFID reader, one of skill in the art will recognize that any number of inventory control devices can be utilized without deviating from the inventive concepts disclosed herein. For example, one alternate embodiment can utilize a bar code scanner capable of reading a bar code or other identifying mark attached to each medical item located within a particular container 13. To this end, the tracked bar code scanner 14a can be positioned within the cabinet 10 and located above the container 13 to which it is assigned. As the container is opened or closed, the bar code scanner can pass over the entire container 13 and scan a barcode attached to each medical item. In yet another alternate embodiment, inventory module 14 can include an image recognition system (i.e., CCD, CMOS, digital, video, etc.) capable of identifying medical items by their markings or based on the physical shape of the particular medical item container. Such an image recognition system would work essentially the same as the bar code scanner above, and would utilize product image descriptions stored within the memory of the central control unit 32.

To this end, the cabinet 10 and/or each container 13 can include one or more separate inventory control modules 14 which can be the same (i.e. two RFID readers 14) or different (i.e. a bar code scanner 14a combined with an RFID reader 14, for example). Such a feature can allow for redundancy in providing an accurate accounting of all objects within each container.

As the access controlled medication storage and inventory control cabinet 10 is designed to store valuable and/or regulated items, one embodiment of the cabinet can further include one or more cameras configured to record transactions with a user. To this end, a first camera 15a can be secured to the outside of the main body 11 in order to capture images of anyone attempting to access the cabinet itself. Additionally, a second camera 15b can be secured to the inside of the main body 11f in order to provide a video record of each medical item removed by a particular user. Such a feature can act to provide a visual record of all cabinet transactions, and can be further useful for ensuring that employees follow company and/or regulatory guidelines when dealing with controlled substances. As described herein, a camera can include any type of optical capture system including but not limited to a lens based camera, CMOS or CCD camera, as well as a video or still camera.

In one alternate embodiment, the cabinet 10 can further include a motion detection sensor 15c capable of detecting motion near the cabinet. Upon detecting motion, the unit can activate the camera 15a and/or the control panel 30 described below. Common examples of suitable motion detection sensors suitable for use with the present invention include, but are not limited to ultrasonic, microwave, and tomographic detectors.

In one preferred embodiment, the access controlled medication storage and inventory control cabinet 10 can further include a biometric identification unit 35, configured to positively identify a person attempting to access the cabinet. As described herein, the biometric identification unit 35 can include any number of commercially available devices capable of positively identifying a user based on a unique physical characteristic. Examples of suitable biometric identification units include, but are not limited to, commercially available fingerprint, handprint, retinal and facial recognition systems, among many others.

Although described above as utilizing biometrics, other secure identification devices ranging from access card readers, key fob readers, manual keypad and/or passcode systems are also contemplated.

The central control unit 30 can act to control the various functions of the access controlled medication storage and inventory control cabinet 10. In one embodiment, the control unit can function as a gatekeeper for controlling access to the cabinet itself (via the biometric identification unit 35, and the locks 16) and/or to particular containers 13 based on a user's predetermined permission settings. Additionally, the central control unit can interface with the various inventory control modules 14 in order to store and report an accurate inventory of all medical items located within the cabinet.

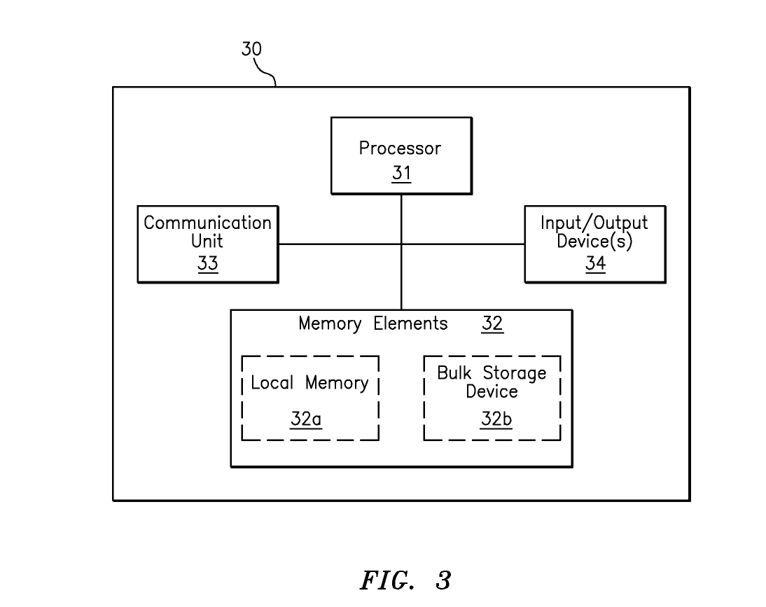

FIG. 3 illustrates a block diagram of one embodiment of a central control unit 30 that includes a processor 31 being conventionally connected to an internal memory 32, a communications unit 33 and a plurality of input/output devices 34.

The processor 31 can act to execute program code stored in the memory 32 in order to allow the apparatus to perform the functionality described herein. Processors are extremely well known in the art, therefore no further description will be provided.

Memory 32 can act to store operating instructions in the form of program code for the processor 31 to execute. As shown in FIG. 3, memory 32 can include one or more physical memory devices such as, for example, local memory 32a and/or one or more bulk storage devices 32b. As used herein, local memory can refer to random access memory or other such memory device(s) generally used during actual execution of program code, whereas a bulk storage device can be implemented as a persistent data storage device. Additionally, memory 32 can also include one or more cache memories that provide temporary storage of at least some program code in order to reduce the number of times program code must be retrieved from the bulk storage device during execution. Each of these devices are well known in the art.

The communication unit 33 can act to allow the central control unit 30 to communicate with external devices. As described herein, the communication unit can include any number of known devices such as a transmitter and receiver configured to send and receive wired and/or wireless communications (i.e. radio frequency, infrared, Bluetooth, microwave, etc.), as well as network adapters (i.e., Modems, cable modems, Ethernet cards, WAN and LAN adapters). To this end, the communication unit can provide two way communication with other devices such as computer systems, remote printers, and/or remote storage devices through intervening private or public networks.

In one alternate embodiment, the communication unit 33 can include any number of components capable of transferring data between the apparatus and a secure media card. For example, the communication unit can include a USB port, disc drive and/or writable CD drive configured to send and receive information with removable media devices ranging from a secure/writable CD, or access controlled/password protected flash drive, for example.

One or more input/output devices can also be included with the cabinet. Several examples of suitable I/O devices which are illustrated in FIG. 2 include a speaker 34a, one or more push buttons/keypads 34b, a display 34c and a microphone 34d.

In one preferred embodiment, the display 34c can include a Graphic User Interface (GUI) capable of providing two way communication with a user and the processor 31. To this end, GUI screen 34c can preferably include a color touch screen monitor for providing a menu of actions that a user can perform. As will be described below, a GUI interface 34c can allow a user to sign for medications, gain access to the cabinet itself, and display an up to the minute inventory of all medical items that have been removed from the cabinet by the user. Alternatively, when the cabinet is not in use, the GUI screen 34c can display general information such as advertising, for example. To this end, the GUI screen 34c can perform multiple tasks during and between cabinet usage periods.

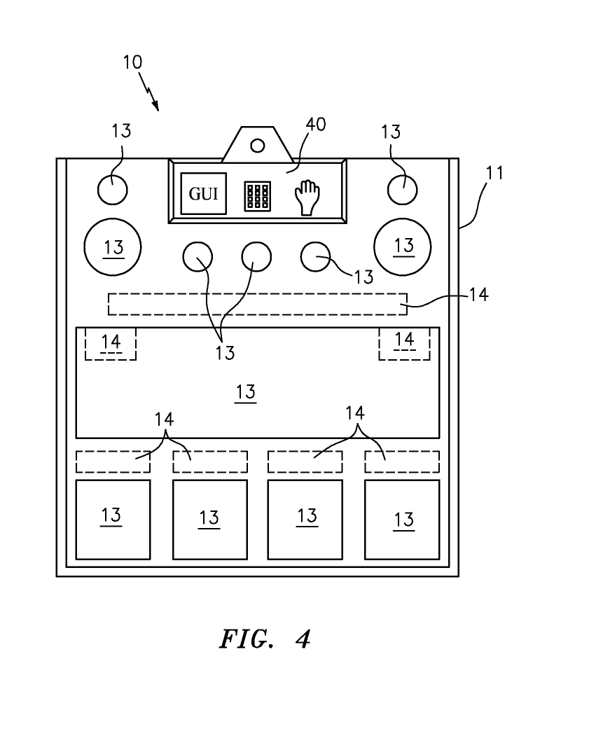

Although described above as separate individual elements, one of skill in the art will recognize that one or more elements of the central control unit can be combined to form a singular component. To this end, FIG. 4 illustrates an alternate embodiment of a access controlled medication storage and inventory control cabinet 10 that further includes an integrated identification and control unit 40. As shown, the integrated central control unit 40 can combine the functionality of the central controller 30, the GUI screen 34c, one or more of the I/O devices 34, the verification unit 35 the camera 15a and/or the motion sensor 15c into a single compact device. In one preferred embodiment, the integrated controller 40 can comprise a tablet pc, for example, running a commercially available operating system configured to perform the various functionality described above.

Finally, although not illustrated, one alternate embodiment of the cabinet 10 can further include a battery backup system configured to allow the cabinet to function in the event that the main power to the device is lost.

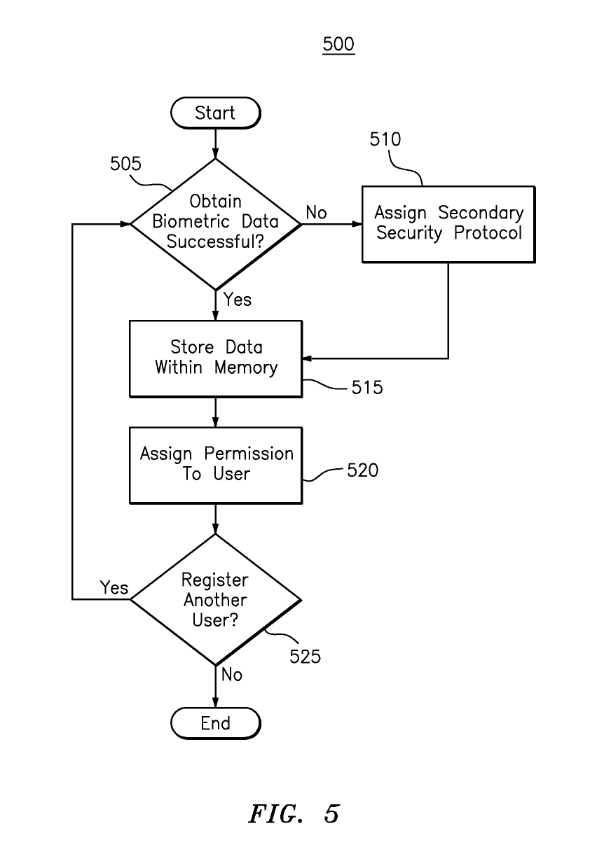

FIG. 5 is a flow chart illustrating a method 500 for registering a user and establishing permission settings for accessing the medication storage and inventory control cabinet described above.

The method can begin by establishing credentials for interfacing with the cabinet. This process can include step 505 where biometric data such as fingerprint, retinal, facial, or handprint readings from an individual are captured. Alternatively, the system can capture a voice sample from the user via the microphone 34d. Additionally, the method can proceed to step 510 where a user can be assigned a numeric code and/or physical device such as a key fob or access card having a registration unique to that particular user.

Next, the method can proceed to step 515 where the user data can be stored within the memory 32 for access by the processor 31.

Next, the method can proceed to step 520 where a permission can be assigned to the user. To this end, each user can be assigned a unique or group permission setting which will enable the user to access only those containers 13 within the cabinet 10 that are pre-approved for that permission setting. For example, a doctor may have a permission setting that allows full access to each container, whereas a nurse may only have a permission setting that allows access to a particular container. In one embodiment, permission settings can be stored within the memory 32 at the time of the user registration.

In step 525, additional users can be registered by returning to step 505, otherwise the method can terminate.

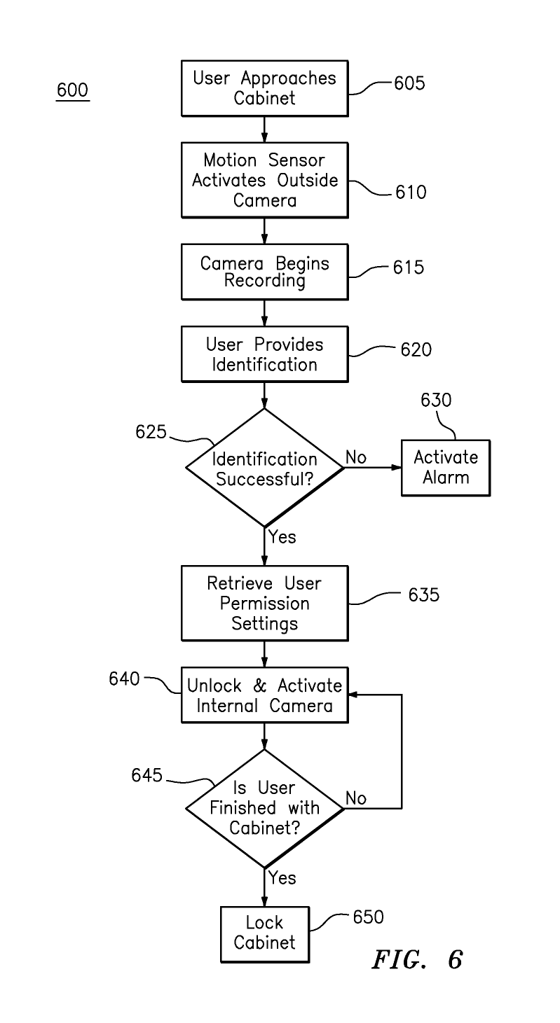

FIG. 6 is a flow chart illustrating a method 600 for accessing items located within the medication storage and inventory control cabinet described above.

The method can begin at steps 605 and 610 where a user approaches the cabinet, and the motion sensor activates the camera. In step 615 the outside camera records the users actions.

Next, the user can provide identification to the cabinet. Identification can be established by utilizing the biometric identification unit 35, or one of the I/O devices 34 as assigned to the user during the registration process.

If the user is not recognized, the method can proceed to step 630 where the user may be allowed to repeat the identification procedure again, or may immediately activate an alarm (such as emitting a sound through the speaker 34a and/or transmitting a distress signal via the communication unit 34.

If the user is recognized, the method can proceed to step 635 where the processor 31 can retrieve the user permission settings from the memory 32. Upon receiving the permission settings, the method can proceed to step 640 where the processor can activate the internal camera 15b, unlock the cabinet door 12 and unlock the particular containers 13 to which the users permission settings allow access.

Next, in step 645, a determination can be made as to whether the user has finished using the cabinet. This determination can be based on the occurrence of a specific event or upon the passage of a predetermined period of time. For example, if the system detects that the outer door 12 has been closed, the method can proceed to step 650 where the system can lock all containers and the door 12 and deactivate the internal camera.

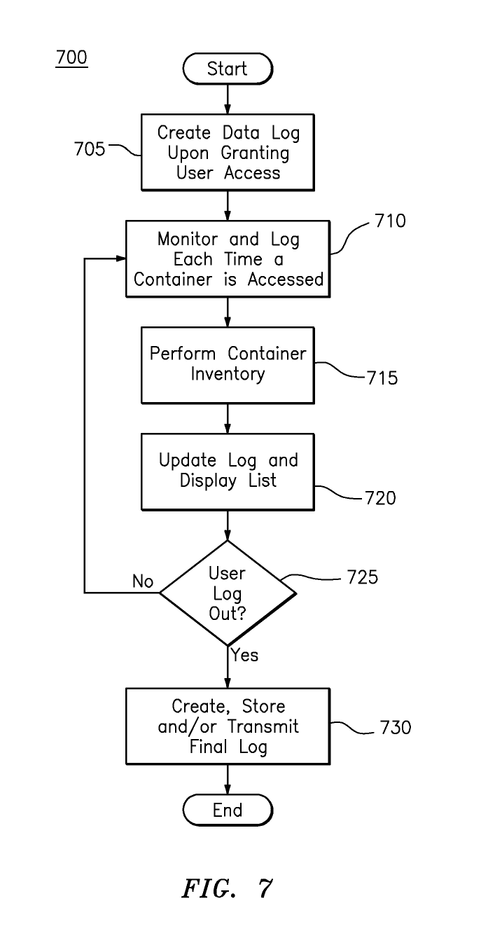

FIG. 7 is a flow chart illustrating a method 700 for performing product inventory utilizing the medication storage and inventory control cabinet described above.

The method can begin at step 705 where a pre-registered user can access the control panel and select a patient name and/or patient number. Upon entry of this information, the system can create a data log in the memory 32 of the central control unit 30 that will include the video from cameras 15a and 15b, along with a date and time stamp. This log will remain open until the user logs out of the system.

Next, the method can proceed to step 710 where the central control unit 30 can monitor which containers are accessed by the user. Such a feature can be accomplished by determining which of the electromagnetic locks are opened and noting the container to which the lock is assigned.

Upon determining that a container 13 has been accessed, the method can proceed to step 715 where the inventory control module(s) 14 associated with the accessed container can determine which, if any, medical items have been removed from the container. This information can also be compared with the visual record provided by the internal camera 15b.

In step 720, the removed items can be noted in the data log, and displayed on the monitor 34c.

Steps 710-720 can be repeated until the user logs out at step 725 or the cabinet automatically logs the user out. As described above, upon determining that the user has logged out (or sensing inactivity for a predetermined period of time) the cabinet will lock the door 12 and all containers 13.

Finally, the method will proceed to step 730 where the final inventory count will be stored within the memory 32 and/or transmitted to an external device via the communication unit 33. For example, the communication unit 33 can transmit the log containing the record of all anesthesiology items taken, the picture/video of the user and the time/date details to an external device such as a hospital administrator or remote monitoring agency, for example. This information can then be relayed to other departments ranging from the patients' primary care physician, billing, and/or other related parties.

In addition to the above noted uses, the medication storage and inventory control cabinet described above can be particularly useful for doctor offices which routinely deal with sample medication. To this end, the device can be utilized, as described above, to store and dispense medication samples while capturing doctor signatures for each patient. In this regard, the doctor signature can include the biometric data or other information used to access the cabinet. This information can then be stored in the cabinet memory 31, or transmitted to a secure media card (i.e. secure flash drive) and/or a pharmaceutical company/pharmacy, as required by various regulatory bodies.

Moreover, the above description can be equally applicable to the handling of controlled substances, such as narcotics, for example. To this end, the cabinet can be utilized to create a secure prescription for the dispensement of these substances and provide the same to a requesting pharmacy or directly to a user via a secure media card for hand delivery to their pharmacy of choice.

Accordingly, the medication storage and inventory control cabinet can provide secure storage and access to medical items while maintaining accurate product status for billing, inventory and regulatory purposes.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An access controlled medication storage and inventory control apparatus comprising:
a main body having a top wall, a bottom wall, a back wall and a pair of opposing side walls forming a cavernous interior space;
a door hingedly secured to one of said walls, said door being configured to limit access to the cavernous interior space;
one or more locks configured to secure the door in a closed position;
a plurality of containers stored within the cavernous interior space, each of said containers being configured to store medical items;
an inventory control module configured to identify each of the medical items stored within the containers; and
a central control unit configured to interface with a user and control each of the inventory control module and the one or more locks.

2. The apparatus of claim 1, wherein the inventory control module includes at least one of an RFID reader, a bar code scanner, and an image recognition system.

3. The cabinet of claim 2, further comprising a plurality of inventory control modules, wherein at least one of said plurality of inventory control modules is different from another of the plurality of inventory control modules.

4. The apparatus of claim 1, wherein at least one of the plurality of containers further includes an electronic lock configured to be remotely operated by the control unit.

5. The apparatus of claim 1, further comprising:
a user identification unit configured to positively identify a user,
wherein said identification unit includes at least one of a biometric scanner, a voice scanner, an access card reader, a key fob scanner and a keypad.

6. The apparatus of claim 1, further comprising:
a Graphic User Interface configured to provide two way communication with a user.

7. The apparatus of claim 1, further comprising:
at least one camera configured to record a user interaction with the apparatus.

8. The apparatus of claim 7, further comprising:
a motion sensor configured to activate at least one of the control unit and the camera upon detecting movement near the apparatus.

9. The apparatus of claim 1, wherein the central control unit includes
a processor configured to control apparatus components;
a memory configured to store operating instructions;
a communication unit configured to send and receive data with an external device; and
at least one of a speaker, keypad, display and microphone.

10. The apparatus of claim 9, wherein the communication unit includes at least one of a transmitter/receiver and a network adapter.

11. The apparatus of claim 9, wherein the communication unit is configured to send and receive data with a secure media card.

12. The apparatus of claim 9, wherein said central control unit includes a tablet pc.

13. The apparatus of claim 12, wherein said tablet pc further includes at least one of an identification unit, a camera and a motion sensor.

14. The apparatus of claim 1, wherein said lock includes an electromagnetic lock configured to be operated by the central control unit.

15. The apparatus of claim 1, wherein said main body further includes an antimicrobial coating configured to prevent the spread of contagions.

16. The apparatus of claim 1, further comprising:
a waste compartment having an opening configured to receive discarded medical items.

17. The apparatus of claim 1, further including:
one or more tamper switches configured to raise an alarm when disturbed by an unauthorized user.

18. The apparatus of claim 1, further comprising:
a location tracking device configured to notify a remote device of the apparatus location.

19. The apparatus of claim 1, wherein at least one of said containers is climate controlled.

20. An access controlled medication storage and inventory control apparatus comprising:
a main body having a top wall, a bottom wall, a back wall and a pair of opposing side walls forming a cavernous interior space;
a door hingedly secured to one of said walls, said door being configured to limit access to the cavernous interior space, said door further including at least one electronic lock configured to secure the door in a closed position;
a plurality of containers stored within the cavernous interior space;
at least one of said containers including a second electronic lock configured to secure the container in a closed position;
one or more medical items stored within at least one of said containers;
an inventory control module configured to identify each of the medical items stored within the containers, said inventory control module being further configured to identify when one or more of the medical items are removed from the container;
a central control unit configured to interface with a user and control each of the inventory control module and the first and second electronic lock; and
a communication unit configured to send and receive inventory information with an external device.

21. The apparatus of claim 20, wherein said apparatus is affixed to a permanent location.

22. The apparatus of claim 20, wherein said apparatus is mobile.

23. A method for accessing and tracking medical items contained within the apparatus of claim 1, said method including:
detecting, the presence of a user via a motion sensor;
activating an external camera;
receiving a user identification;
authenticating the user identification;
retrieving a user permission setting from a memory;
creating a user log within the memory;
instructing each of the one or more door locks to open;
instructing a lock secured to one or more of the containers to open activating an internal camera;
monitoring the presence of inventory via the inventory control module;
updating the user log with a result of the monitoring;
instructing the lock secured to one or more of the containers to close;
instructing each of the one or more door locks to close; and
transmitting the user log via a communication unit.

24. The method of claim 23, wherein said medical items include sample medication, and said transmitting further includes sending the user log to one of a pharmacy and a secure media card.

25. The method of claim 23, wherein said medical items include controlled substances, and said transmitting further includes sending the user log to one of a pharmacy and a secure media card.
